(19) United States
(12) Patent Application Publication
(10) Pub. No.: US 2026/0260492 A1
(43) Pub. Date: Sep. 3, 2026

(54) INFORMATION PROVIDING DEVICE, ACCIDENT INFORMATION PROVIDING METHOD, AND PROGRAM RECORDING MEDIUM

(71) Applicant: NEC Corporation, Minato-ku, Tokyo (JP)

(72) Inventors: Nozomi MATSUMOTO, Tokyo (JP); Hitomi ITO, Tokyo (JP); Yoko TANAKA, Tokyo (JP); Masaru YANAI, Tokyo (JP); Sawaka SEKI, Tokyo (JP); Kosei KOBAYASHI, Tokyo (JP)

(73) Assignee: NEC Corporation, Minato-ku, Tokyo (JP)

(21) Appl. No.: 18/846,698

(22) PCT Filed: Mar. 24, 2022
(86) PCT No.: PCT/JP2022/013968

§ 371 Date: Sep. 13, 2024

(51) Int. Cl. G06V 20/52; G08B 21/18; H04N 7/18

(52) U.S. Cl. CPC G06V 20/52; G08B 21/18; H04N 7/18

(57) ABSTRACT

This information providing device comprises one or more memories storing instructions; and one or more processors configured to execute the instructions to: acquire images from an image storing that stores, for a given time period, the images obtained by imaging a to-be-monitored object; detect, on the basis of a change in the images, the occurrence of an accident that has damaged the to-be-monitored object; in a case of detecting the occurrence of the accident, select, from the image storing, first images before the occurrence of the accident; and in the case of detecting the occurrence of the accident, transmit, to a predetermined terminal, the first images and the information about a part of the to-be-monitored object where the change has been detected.

### TECHNICAL FIELD

The present invention relates to an information providing device, an accident information providing method, and a program recording medium.

### BACKGROUND ART

PTL 1 discloses an image monitoring device capable of highly efficient image monitoring. According to PTL 1, the image monitoring device receives a moving image of a monitoring region captured by an external monitoring camera and records the moving image as image information including still images of predetermined frames in association with the monitoring camera and an imaging time. Then, the image monitoring device receives the moving image, performs image analysis on the moving image to extract a plurality of predetermined types of events, and stores the extracted event information for each type in association with the monitoring camera and the imaging time. Further, the image monitoring device provides the recorded image information and the stored event information to the outside.

### CITATION LIST

### Patent Literature

PTL 1: JP 2007-243342 A

### SUMMARY OF INVENTION

### Technical Problem

In a case where a public object is damaged due to a vehicle accident or the like, a driver reports the damage to the police, and after handling the accident, repair and compensation for the damaged public object are carried out. At this time, it may be difficult to specify a portion damaged by the accident. In addition, when there is no victim, a hit-and-run incident may occur. In this regard, in the invention of PTL 1, the moving image of the monitoring region captured by the monitoring camera is input, and only the recorded image information and the stored event information are provided to the outside when a specific event is extracted.

An object of the present invention is to provide an information providing device, an accident information providing method, and a program recording medium that can contribute to facilitating specification of occurrence of damage when a monitoring target object is damaged by an accident and identification of a damaged portion.

### Solution to Problem

According to a first aspect, there is provided an information providing device including: image acquisition means for acquiring an image obtained by imaging a monitoring target object from image storage means for storing the image for a predetermined period; accident detection means for detecting occurrence of an accident that has caused damage to the monitoring target object based on a change of the image; first image selection means for selecting, in a case where the occurrence of the accident has been detected, an image including an image before the occurrence of the accident from the image storage means; and transmission means for transmitting, in a case where the occurrence of the accident has been detected, the image selected by the first image selection means and information regarding a portion where the change of the monitoring target object is detected to a predetermined terminal.

According to a second aspect, there is provided an accident information providing method including: acquiring an image obtained by imaging a monitoring target object from image storage means for storing the image for a predetermined period; detecting occurrence of an accident that has caused damage to the monitoring target object based on a change of the image; and transmitting, in a case where the occurrence of the accident has been detected, an image before the occurrence of the accident from the image storage means and information regarding a portion where the change of the monitoring target object is detected to a predetermined terminal.

According to a third aspect, there is provided a program recording medium storing a program for causing a computer to execute processing of: acquiring an image obtained by imaging a monitoring target object from image storage means for storing the image for a predetermined period; detecting occurrence of an accident that has caused damage to the monitoring target object based on a change of the image; and transmitting, in a case where the occurrence of the accident has been detected, an image before the occurrence of the accident from the image storage means and information regarding a portion where the change of the monitoring target object is detected to a predetermined terminal.

### Advantageous Effects of Invention

According to the present invention, there are provided an information providing device, an accident information providing method, and a program recording medium capable of facilitating specification of occurrence of damage when a monitoring target object is damaged by an accident and a damaged portion.

### BRIEF DESCRIPTION OF DRAWINGS

FIG. 1 is a diagram illustrating a configuration according to an example embodiment of the present invention.

FIG. 2A is a diagram for describing an operation according to an example embodiment of the present invention.

FIG. 2B is a diagram for describing the operation according to an example embodiment of the present invention.

FIG. 3 is a diagram for describing the operation according to an example embodiment of the present invention.

FIG. 4A is a diagram for describing the operation according to an example embodiment of the present invention.

FIG. 4B is a diagram for describing the operation according to an example embodiment of the present invention.

FIG. 5 is a diagram for describing the operation according to an example embodiment of the present invention.

FIG. 6 is a diagram illustrating a configuration according to a first example embodiment of the present invention.

FIG. 7 is a flowchart illustrating an operation of an information providing device according to the first example embodiment of the present invention.

FIG. 8 is a diagram illustrating an example of information transmitted by the information providing device according to the first example embodiment of the present invention.

FIG. 9 is a diagram illustrating a configuration according to a second example embodiment of the present invention.

FIG. 10 is a diagram illustrating a camera arrangement example in the second example embodiment of the present invention.

FIG. 11 is a flowchart illustrating an operation of an information providing device according to the second example embodiment of the present invention.

FIG. 12 is a diagram illustrating an example of information transmitted by the information providing device according to the second example embodiment of the present invention.

FIG. 13 is a diagram illustrating a configuration according to a third example embodiment of the present invention.

FIG. 14 is a diagram illustrating an example of monitoring target object information held by an information providing device according to the third example embodiment of the present invention.

FIG. 15 is a flowchart illustrating an operation of the information providing device according to the third example embodiment of the present invention.

FIG. 16 is a diagram for describing a modified example embodiment of the present invention.

FIG. 17 is a diagram illustrating an example of monitoring target object information held by an information providing device according to the modified example embodiment of the present invention.

FIG. 18 is a diagram illustrating another example of the monitoring target object information held by the information providing device according to the modified example embodiment of the present invention.

FIG. 19 is a diagram illustrating a configuration of a computer that can function as the information providing device of the present invention.

### EXAMPLE EMBODIMENT

First, an outline of an example embodiment of the present invention will be described with reference to the drawings. Note that reference numerals in the drawings for this outline denote elements for convenience as an example for assisting understanding, and are not intended to limit the present invention to the illustrated aspects. In addition, connection lines between blocks in the drawings and the like referred to in the following description include both bidirectional lines and unidirectional lines. A unidirectional arrow schematically indicates a main flow of a signal (data), and does not exclude bidirectionality. A program is executed via a computer device, and the computer device includes, for example, a processor, a storage device, an input device, a communication interface, and a display device as necessary. In addition, the computer device is configured to be able to communicate with a device (including a computer) inside or outside the device via the communication interface, whether wired or wireless. Ports and interfaces provided at connection points of input and output of each block are omitted in the drawings.

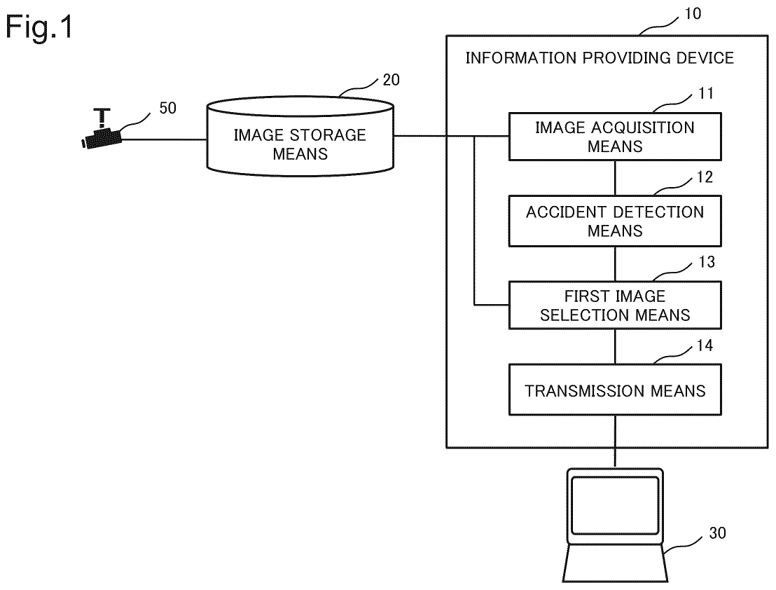

In an example embodiment of the present invention, as illustrated in FIG. 1, the present invention can be implemented by an information providing device 10 including image acquisition means 11, accident detection means 12, first image selection means 13, and transmission means 14.

More specifically, the image acquisition means 11 acquires, from the image storage means 20 that stores an image obtained by imaging a monitoring target object for a predetermined period, the image. The image storage means 20 is implemented by a storage, a server, or the like that receives, from a camera 50 or the like capable of imaging a monitoring target object, the image obtained by imaging the monitoring target object and stores the image for a predetermined period.

The accident detection means 12 detects, based on a change of the image, occurrence of an accident that has caused damage to the monitoring target object.

In a case where the occurrence of the accident is detected, the first image selection means 13 selects an image including an image before the occurrence of the accident from the image storage means.

In a case where the occurrence of the accident is detected, the transmission means 14 transmits, to a predetermined terminal 30, the image selected by the first image selection means and information regarding a portion where the change of the monitoring target object is detected. A terminal of an owner of the monitoring target object or a property insurance company can be considered as the predetermined terminal 30.

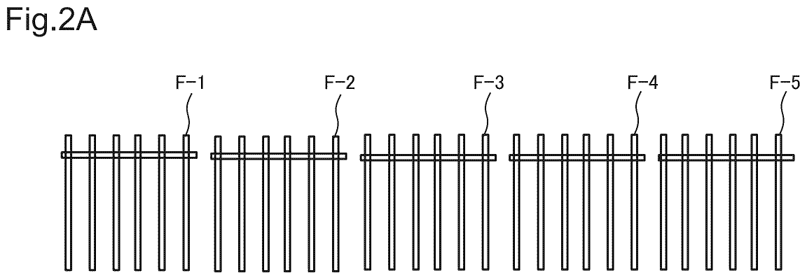

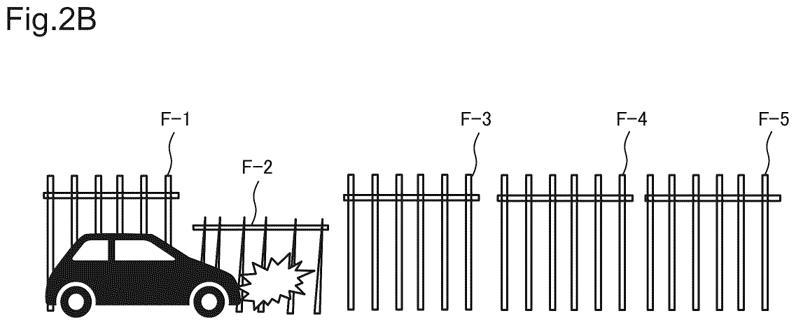

FIG. 2A illustrates a state in which fences F-1 to F-5 are imaged by the camera 50 as monitoring target objects. For example, an operation of the information providing device 10 of the present example embodiment will be described with an example in which an image of a process in which a vehicle collides with the fence F-2 and the fence F-2 collapses as illustrated in FIG. 2B is recorded in the image storage means 20.

As described above, the image acquisition means 11 acquires images of the fences F-1 to F-5 from the image storage means 20, and sends the images to the accident detection means 12. The images acquired by the image acquisition means 11 from the image storage means 20 may be moving images or still images captured at regular time intervals.

The accident detection means 12 detects that the fence F-2 has collapsed based on the change of the image.

In a case where the collapse of the fence F-2 is detected, the first image selection means 13 selects the image of the fence F-2 before the occurrence of the accident from the image storage means 20. The image of the fence F-2 before the occurrence of the accident can be obtained very simply by acquiring, from the image storage means 20, a past image from a predetermined time before a time point when the collapse of the fence F-2 is detected. It is a matter of course that it is also possible to adopt a method of scanning the past image and retrieving the image of the fence F-2 before the change occurs from the image storage means 20.

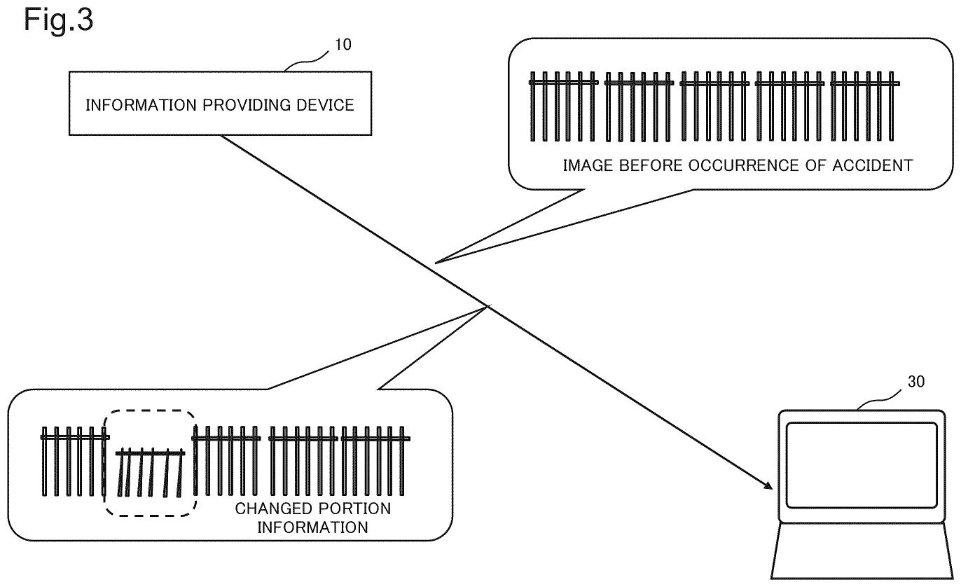

In a case where the collapse of the fence F-2 is detected, the transmission means 14 transmits, to the predetermined terminal 30, the image selected by the first image selection means 13 illustrated in FIG. 3 and information regarding the fence F-2 indicating the relevant portion among the fences F-1 to F-5.

In the example of FIG. 3, the information providing device 10 transmits, to the predetermined terminal 30, the images of the fences F-1 to F-5 before the occurrence of the accident and the image showing that the fence F-2 among the fences F-1 to F-5 has collapsed. A user of the predetermined terminal 30 can accurately grasp the fact that the fence F-2 has collapsed and the degree of damage caused by the accident by viewing the images. In the example of FIG. 3, the information providing device 10 transmits the image showing all of the fences F-1 to F-5 to the predetermined terminal 30, but the information providing device 10 may also cut out and transmit only the image of the fence F-2.

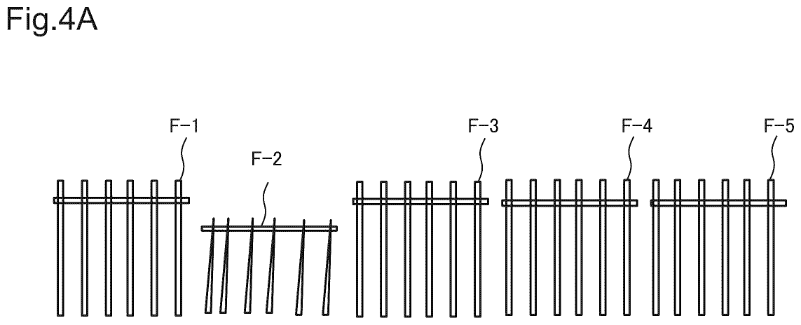

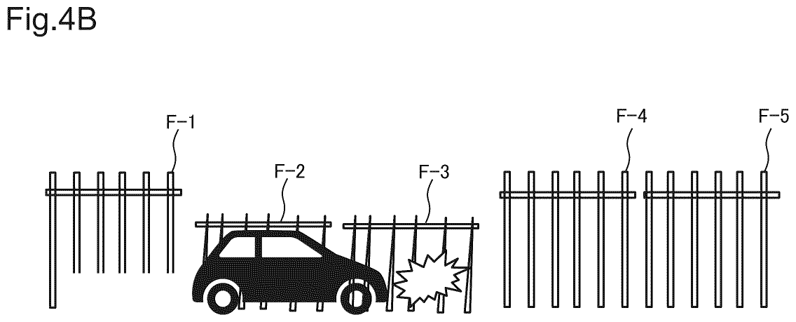

Furthermore, according to the present example embodiment, it is possible to accurately grasp the degree of damage caused by a subsequent accident. For example, as illustrated in FIGS. 4A and 4B, the fence F-3 may collapse due to another accident after the collapse of the fence F-2 at a location where single vehicle accidents frequently occur.

Also in this case, the accident detection means 12 detects that the fence F-3 has collapsed based on the change of the image.

In a case where the first image selection means 13 detects that the fence F-3 has collapsed, the first image selection means 13 selects the image of the fence F-3 before the occurrence of the accident from the image storage means 20.

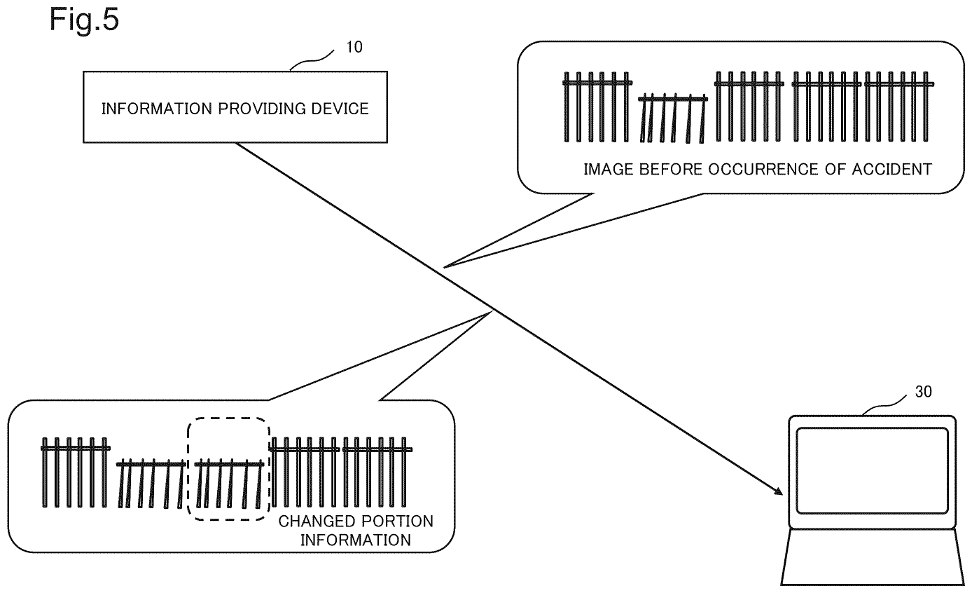

In a case where the collapse of the fence F-3 is detected, the transmission means 14 transmits, to the predetermined terminal 30, the image selected by the first image selection means 13 illustrated in FIG. 5 and information regarding the fence F-3 indicating the relevant portion among the fences F-1 to F-5. The user of the predetermined terminal 30 can accurately grasp the fact that the fence F-3 has newly collapsed due to the second accident and the degree of damage caused by the second accident by viewing the images. As a result, an owner of each of the fences F-1 to F-5 can correctly charge a driver who has caused the first accident and a driver who has caused the second accident for the repair cost. Furthermore, the same applies to a case where the predetermined terminal 30 is a terminal of a property insurance company, and a person in charge of the property insurance company can accurately calculate an insurance amount to be paid for each accident based on the information described above.

### First Example Embodiment

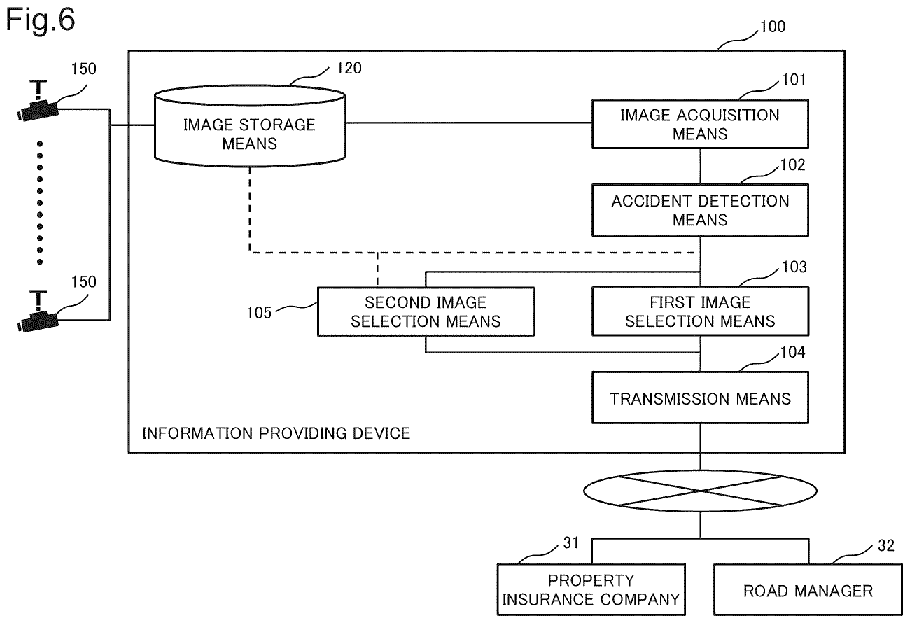

Next, a first example embodiment of the first present invention in which an image of a vehicle that has caused an accident can be provided in addition to an image before the accident will be described in detail with reference to the drawings. FIG. 6 is a diagram illustrating a configuration according to the first example embodiment of the present invention. Referring to FIG. 6, an information providing device 100 that is connected to a plurality of cameras 150 and is capable of transmitting information to terminals 31 and 32 of a road manager and a property insurance company is illustrated. In the following description, it is assumed that the monitoring target objects are the fences F-1 to F-5 illustrated in FIGS. 2A and 2B.

The information providing device 100 includes image storage means 120, image acquisition means 101, accident detection means 102, first image selection means 103, second image selection means 105, and transmission means 104.

The image storage means 120 is implemented by a storage device, a server, or the like that receives, from the camera 150, an image obtained by imaging a monitoring target object and stores the image for a predetermined period. It is sufficient if the period for which the image storage means 120 stores the image is equal to or longer than a period for which the first image selection means 103 and the second image selection means 105 can select necessary images. Furthermore, in the example of FIG. 6, the image storage means 120 is provided inside the information providing device 100, but the image storage means 120 may be constructed in an external storage device or the like accessible by the information providing device 100.

The image acquisition means 101 acquires two images of each of the fences F-1 to F-5 from the image storage means 120, the two images being temporally continuous, and transmits the images to the accident detection means 102.

The accident detection means 102 compares the two images transmitted from the image acquisition means 101, and detects occurrence of an accident by which the fence as a monitoring target object is damaged based on a change between the two images. Specifically, the accident detection means 102 detects the occurrence of the accident based on whether the images of the fences F-1 to F-5 acquired from the image acquisition means 101 have been changed. As a cause of the change of the images of the fences F-1 to F-5, a change due to water splashes, adhesion of foreign matter, or the like is also conceivable in addition to the accident, and thus it is desirable that the accident detection means 102 has a function of identifying such a cause.

In a case where the occurrence of the accident has been detected, the accident detection means 102 transmits information regarding a portion where the change of the images of the fences F-1 to F-5 is detected to the first image selection means 103 and the second image selection means 105, and instructs each of the first image selection means 103 and the second image selection means 105 to select an image. In addition, the accident detection means 102 transmits, to the transmission means 104, information regarding the portion where the change of the images is detected among the fences F-1 to F-5.

The first image selection means 103 selects an image (first image) showing the fence F-2 before the occurrence of the accident from the image storage means 120 based on the information regarding the portion where the change of the image is detected among the fences F-1 to F-5.

The second image selection means 105 selects an image (second image) of the vehicle that has caused the accident from the image storage means 120 based on the information regarding the portion where the change of the image is detected among the fences F-1 to F-5. The image of the vehicle that has caused the accident can be obtained very simply by acquiring, from the image storage means 120, the image of the vehicle traveling near the fence where the change has occurred, among past images before a time point when the change of the images of the fences F-1 to F-5 is detected. It is a matter of course that it is also possible to adopt a method of scanning a past image, detecting a moving object, and analyzing a motion of the moving object to retrieve an image showing the vehicle that has caused the accident from the image storage means 120.

The transmission means 104 transmits the information regarding the portion where the change of the image is detected among the fences F-1 to F-5 and the first and second images selected by the first image selection means 103 and the second image selection means 105 to the terminals 31 and 32 of the property insurance company and the road manager.

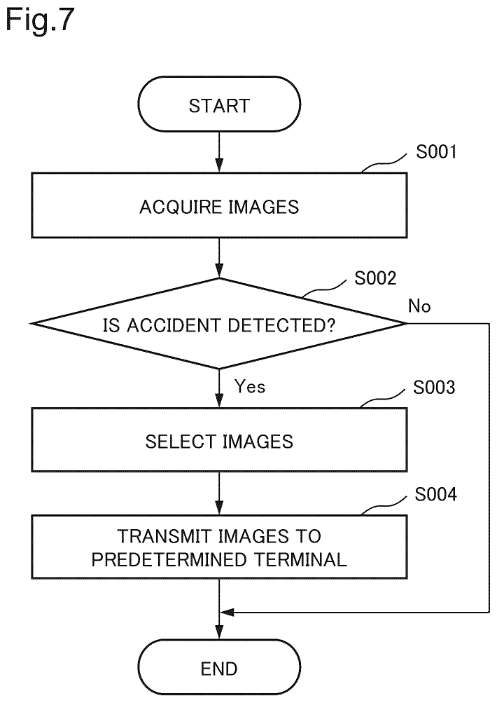

Next, an operation according to the present example embodiment will be described in detail with reference to the drawings. FIG. 7 is a flowchart illustrating an operation of the information providing device 100 according to the first example embodiment of the present invention. Referring to FIG. 7, first, in the information providing device 100, the image acquisition means 101 acquires two images of each of the fences F-1 to F-5 from the image storage means 120, the two images being temporally continuous (step S001). In a case where there are a plurality of monitoring target objects, the following processing is performed in parallel or a plurality of times.

Next, the information providing device 100 compares the acquired two images and detects the occurrence of the accident based on the change between the two images. Specifically, the accident detection means 102 detects the occurrence of the accident based on whether the images of the fences F-1 to F-5 acquired from the image acquisition means 101 have been changed (step S002). In a case where the occurrence of the accident has not been detected, the information providing device 100 omits the subsequent processing.

In a case where the occurrence of the accident has been detected, the information providing device 100 selects the image (first image) of the fence before the occurrence of the accident and the image (second image) of the vehicle that has caused the accident from the image storage means 120 (step S003).

Finally, the information providing device 100 transmits, to the terminals 31 and 32 of the property insurance company and the road manager, the information regarding the portion where the change of the image is detected among the fences F-1 to F-5 and the first and second images selected in step S003 (step S004).

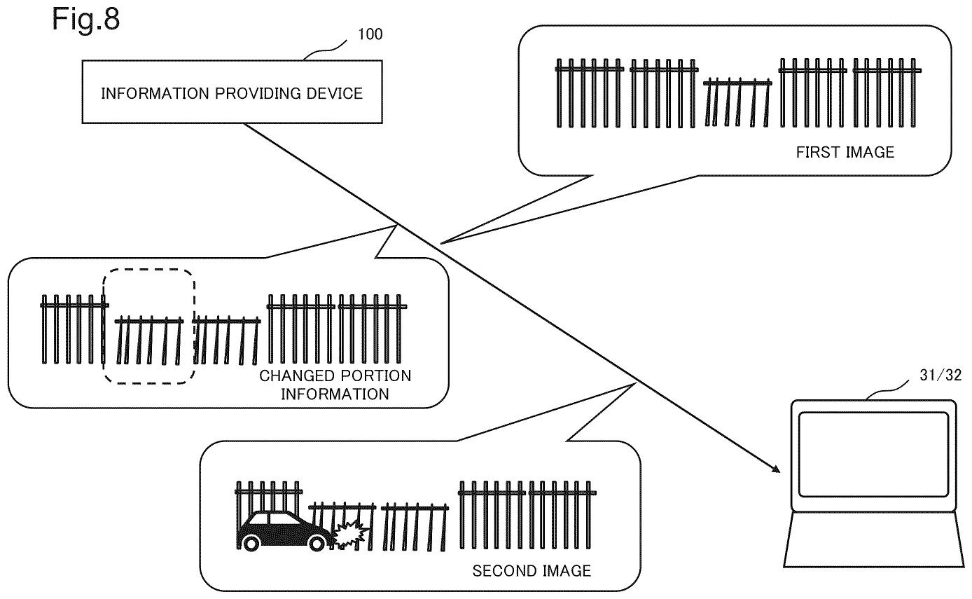

FIG. 8 is a diagram illustrating an example of the information transmitted by the information providing device 100 to the terminals 31 and 32 of the property insurance company and the road manager. In the example of FIG. 8, the information providing device 100 transmits the changed portion information, the first image, and the second image to the terminals 31 and 32 of the property insurance company and the road manager. The changed portion information indicates an accident occurrence portion (change detection portion) with a broken line on the images of the fences F-1 to F-5. The first image is an image before the accident of the fence F-2 whose change has been detected. The second image is an image showing the vehicle that has caused the accident of the fence F-2.

The persons in charge of the property insurance company and the road manager who have browsed these pieces of information can grasp not only the occurrence of the accident that has caused the damage of the fence and a place where the accident has occurred but also the scale of the damage and the involved vehicle. These pieces of information are used for a claim for damages to a driving vehicle or the like by the vehicle involved in the accident and analysis of the cause of the accident. Note that, with the information providing device 100 of the present example embodiment, the image before the accident of the fence F-2 whose change has been detected is transmitted. As a result, it is easy to form an agreement to exclude the fence F-3 collapsed before the accident from a damage compensation target. In addition, it is possible for the property insurance company to reduce a burden for an investigation and payment of an insurance amount.

### Second Example Embodiment

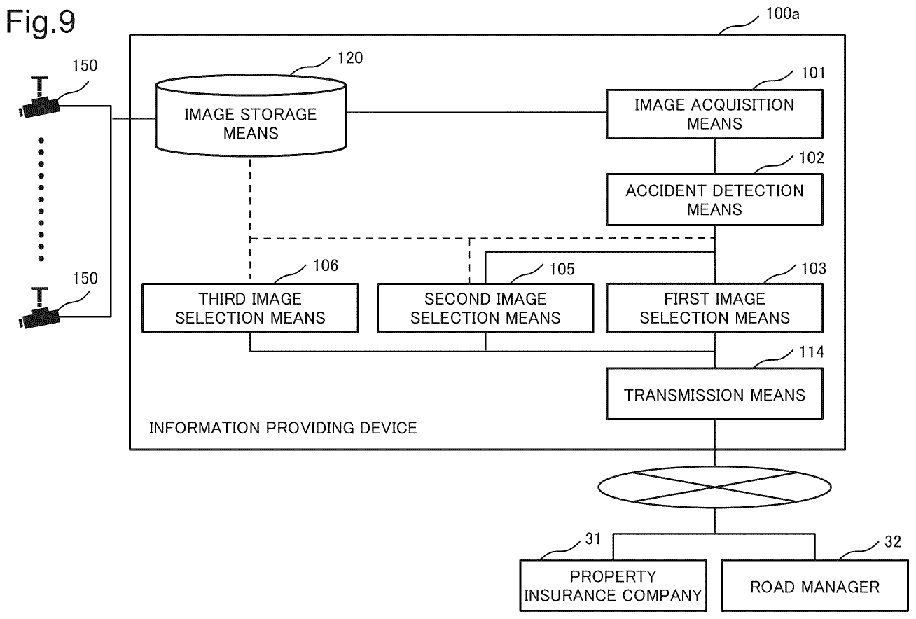

Next, a second example embodiment of the present invention in which the degree of damage of a vehicle that has caused an accident can be grasped will be described in detail with reference to the drawings. FIG. 9 is a diagram illustrating a configuration of an information providing device 100a according to the second example embodiment of the present invention. A difference from the first example embodiment illustrated in FIG. 6 is that arrangement of cameras 150 is changed, the information providing device 100a further includes third image selecting means 106, and transmission means 114 also transmits a third image. Since other configurations are similar to those of the first example embodiment, a description thereof will be omitted, and differences will be mainly described below.

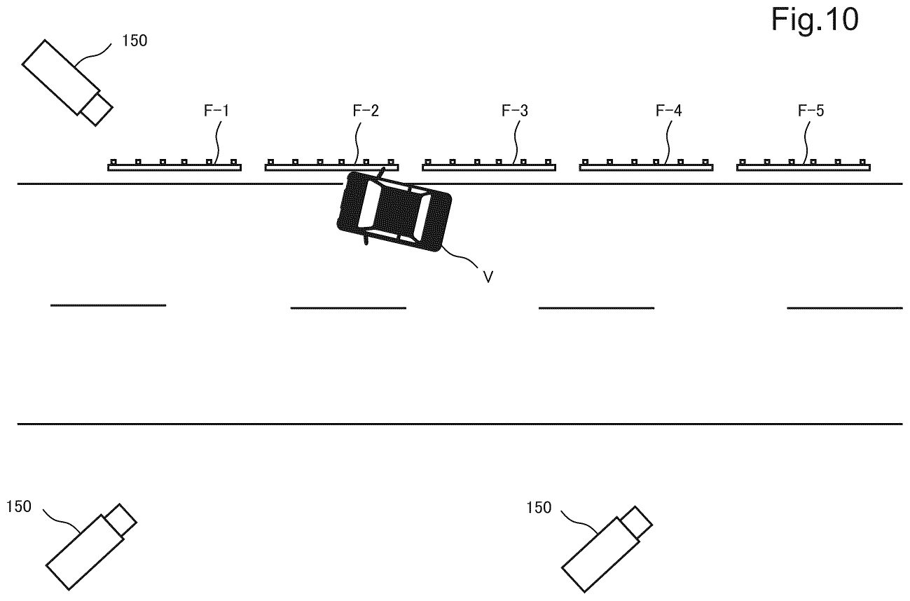

FIG. 10 is a diagram illustrating a camera arrangement example according to the second example embodiment of the present invention. In the present example embodiment, the cameras 150 are arranged at positions where a vehicle V colliding with fences F-1 to F-5 can be imaged as illustrated in the upper part of FIG. 10, in addition to positions suitable for imaging the fences F-1 to F-5 as monitoring target objects. For example, in the example of FIG. 10, the camera 150 on the upper side can image the vehicle V colliding with the fence F-2.

The third image selection means 106 selects an image (third image) before the accident of the vehicle that has caused the accident from image storage means 120 based on information regarding a portion where a change of the image is detected among the fences F-1 to F-5. The image before the accident of the vehicle that has caused the accident can be obtained very simply by acquiring, from the image storage means 120, the image of the vehicle approaching the fence where the change has occurred, among past images before a time point when the change of the images of the fences F-1 to F-5 is detected. It is a matter of course that it is also possible to adopt a method of scanning a past image, detecting a moving object, and analyzing a motion of the moving object to retrieve an image before the accident of the vehicle that has caused the accident from the image storage means 120.

The transmission means 114 transmits the information regarding the portion where the change of the image is detected among the fences F-1 to F-5 and the first to third images selected by the first image selection means 103, the second image selection means 105, and the third image selection means 106 to terminals 31 and 32 of a property insurance company and a road manager.

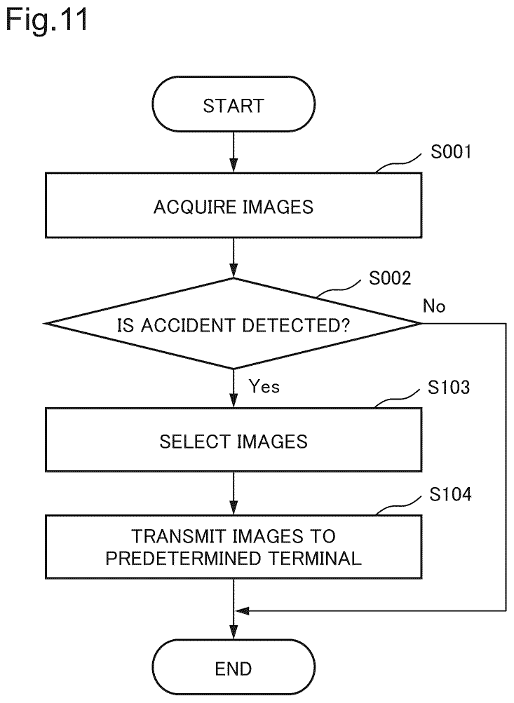

Next, an operation according to the present example embodiment will be described in detail with reference to the drawings. FIG. 11 is a flowchart illustrating an operation of the information providing device 100a according to the second example embodiment of the present invention. A difference from the operation of the information providing device 100 of the first example embodiment illustrated in FIG. 7 is an operation after step S103. Specifically, in a case where the accident has been detected, the information providing device 100a selects the image (first image) of the fence before the occurrence of the accident, the image (second image) of the vehicle that has caused the accident, and the image (third image) before the accident of the vehicle from the image storage means 120 (step S103).

Then, the information providing device 100a transmits, to the terminals 31 and 32 of the property insurance company and the road manager, the information regarding the portion where the change of the image is detected among the fences F-1 to F-5 and the first to third images selected in step S103 (step S104).

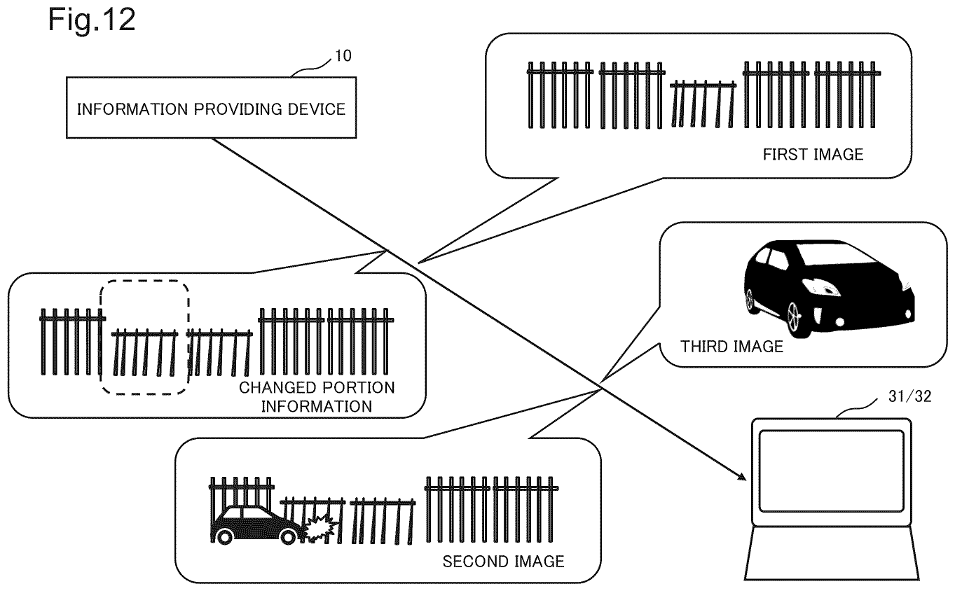

FIG. 12 is a diagram illustrating an example of the information transmitted by the information providing device 100a to the terminals 31 and 32 of the property insurance company and the road manager. In the example of FIG. 12, the information providing device 100a transmits the changed portion information and the first to third images to the terminals 31 and 32 of the property insurance company and the road manager. The third image is an image showing a state before the accident of the vehicle that has caused the accident of the fence F-2.

Persons in charge of the property insurance company and the road manager who have browsed these pieces of information can grasp the degree of damage caused by the accident of the vehicle that has caused the accident in addition to the information obtained from the information providing device 100 of the first example embodiment. As a result, a content of repair required for the vehicle that has caused the accident becomes clear, and payment of a vehicle insurance amount paid from the property insurance company to an insurance subscriber can be refined.

### Third Example Embodiment

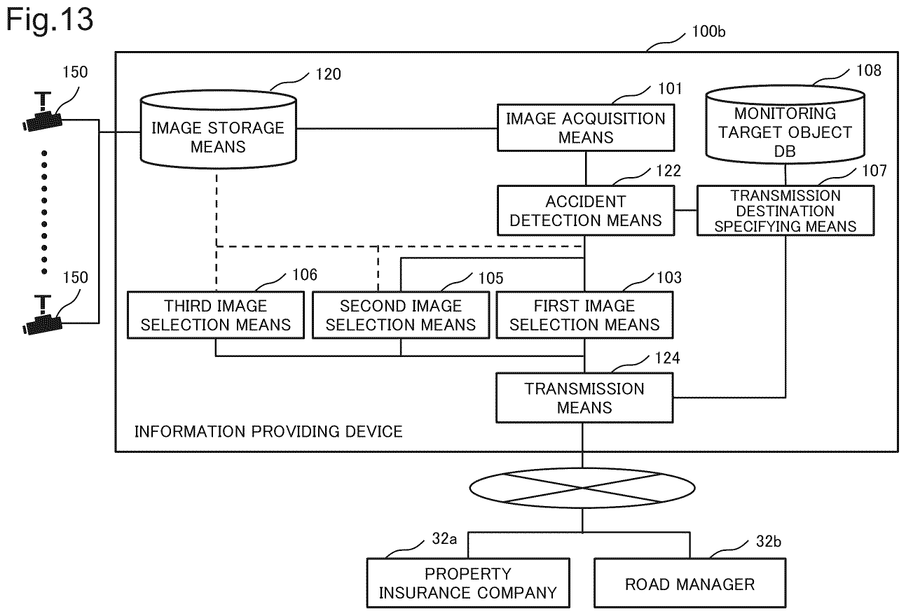

Next, a third example embodiment of the present invention in which a manager of a monitoring target object is specified, and the manager can be quickly contacted in the event of an accident will be described in detail with reference to the drawings. FIG. 13 is a diagram illustrating a configuration of an information providing device 100b according to the third example embodiment of the present invention. The first difference from the second example embodiment illustrated in FIG. 9 is that the information providing device 100b further includes a monitoring target object database (DB) 108 and transmission destination specifying means 107. The second difference is that accident detection means 122 of the information providing device 100b instructs the transmission destination specifying means 107 to specify a transmission destination when the accident is detected, and that transmission means 124 is configured to be able to transmit information to the manager of the monitoring target object involved in the accident among a road manager 32a and a road manager 32b. Since other configurations are similar to those of the second example embodiment, a description thereof will be omitted, and differences will be mainly described below.

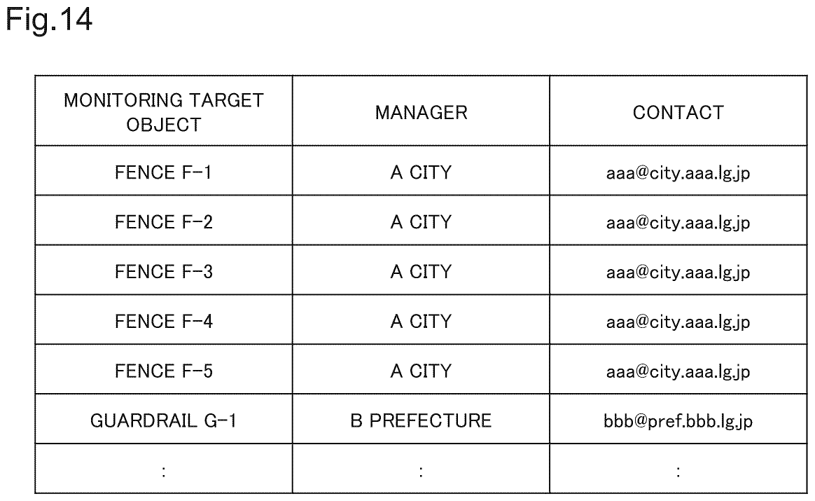

The monitoring target object DB 108 is a database that stores manager information including a contact of the monitoring target object. FIG. 14 is a diagram illustrating an example of monitoring target object information registered in the monitoring target object DB 108. In the example of FIG. 14, a mail address is registered as the contact of the manager for each monitoring target object.

When the accident is detected, the accident detection means 122 transmits information regarding the monitoring target object whose change has been detected to the transmission destination specifying means 107, and requests the specification of the transmission destination.

Upon receiving the information regarding the monitoring target object whose change has been detected from the accident detection means 102, the transmission destination specifying means 107 specifies the contact of the manager of the monitoring target object having the accident by referring to the monitoring target object DB 108, and transmits the contact to the transmission means 124.

The transmission means 124 transmits information regarding a portion where a change of an image is detected among fences F-1 to F-5 and first to third images selected by first to third image selection means 103, 105, and 106 to the contact specified by the transmission destination specifying means 107. Although not illustrated in FIG. 13, a terminal of a property insurance company may be added to the transmission destination as necessary.

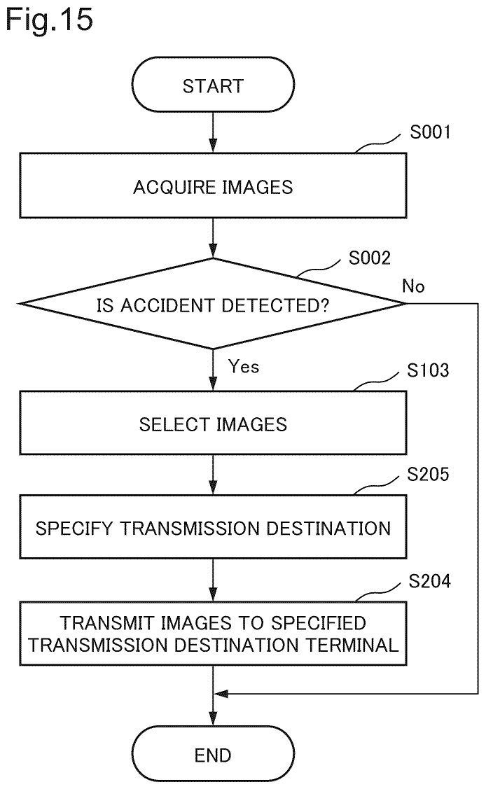

Next, an operation according to the present example embodiment will be described in detail with reference to the drawings. FIG. 15 is a flowchart illustrating an operation of the information providing device 100b according to the third example embodiment of the present invention. A difference from the operation of the information providing device 100 of the first example embodiment illustrated in FIG. 11 is an operation after step S204. Specifically, when the accident is detected, the information providing device 100b selects the first to third images, and then specifies the contact of the manager of the monitoring target object having the accident by referring to the monitoring target object DB 108 (step S205). The processing in step S205 and the processing in step S103 can be executed in a different order or may be executed in parallel.

Then, the information providing device 100b transmits the information regarding the portion where the change of the image is detected among the fences F-1 to F-5 and the first to third images selected in step S103 to the specified contact (step S204).

According to the operation of the third example embodiment as described above, it is possible to transmit necessary information to the manager of the monitoring target object involved in the accident quickly after the occurrence of the accident.

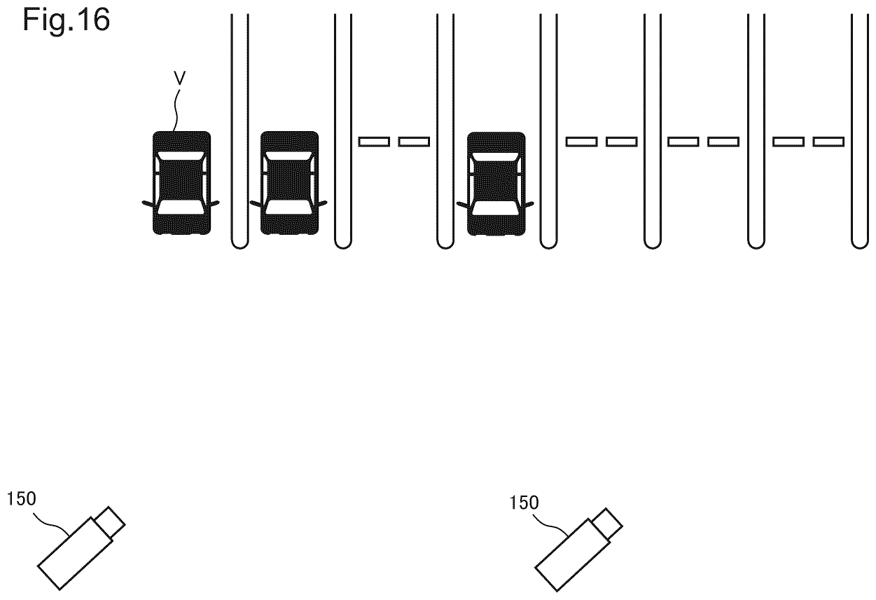

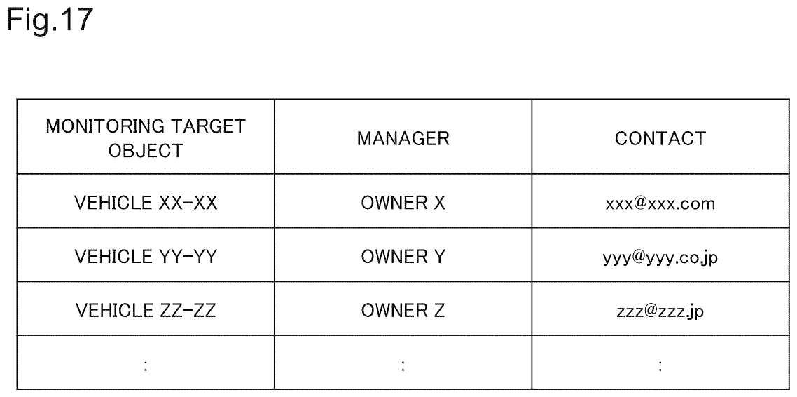

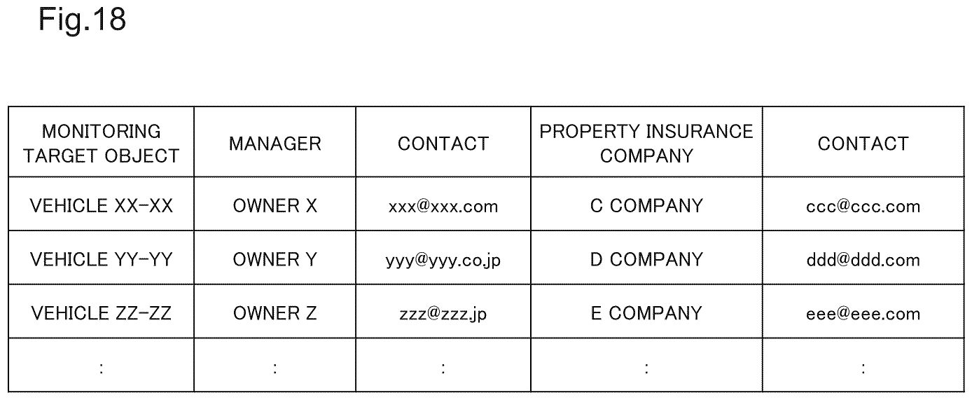

Although an example in which the monitoring target object is a fence has been described in each of the above-described example embodiments, the monitoring target object is not limited to the fence, and may be a guardrail, a utility pole, or a traffic sign. In addition, the monitoring target object does not need to be a land fixture, and may be a vehicle parked in a parking lot or the like. In this case, it is possible to quickly grasp occurrence of an accident in the parking lot by installing the camera 150 in the parking lot and causing the information providing devices 100 to 100b to perform monitoring as illustrated in FIG. 16. Also in this case, the configuration of the third example embodiment can be applied, and the information providing device 100b can be caused to hold information regarding the manager (owner) of the vehicle V as the monitoring target object information as illustrated in FIG. 17. As a result, it becomes possible to promptly transmit necessary information to the owner of the vehicle V damaged by the accident. Furthermore, as illustrated in FIG. 18, not only the information regarding the manager (owner) of the vehicle V but also information regarding an insurance company of an automobile insurance applied to the vehicle V is held, whereby it is possible to automate the contact with the property insurance company.

While the invention has been particularly shown and described with reference to example embodiments thereof, the invention is not limited to these example embodiments, and further modifications, substitutions, and adjustments may be made without departing from the basic technical idea of the present invention. For example, the network configuration, the configuration of each element, and the expression form of data illustrated in the drawings are examples for assisting the understanding of the present invention, and the present invention is not limited to the configurations illustrated in the drawings.

For example, it has been described that the information providing devices 100 to 100b transmit the first to third images to the predetermined terminals 30 and 32 in each of the above-described example embodiments, but the information providing devices 100 to 100b may transmit information with higher added value in addition to the images. For example, a change to a mode in which the information providing devices 100 to 100b create an accident occurrence report by using the first to third images and transmit the accident occurrence report to the predetermined terminals 30 to 32 can be made. Furthermore, a change to a mode in which the information providing devices 100 to 100b cut out a video of the accident and transmits the cut-out video to the predetermined terminals 30 to 32 in addition to the first to third images can be made.

### Hardware Configuration

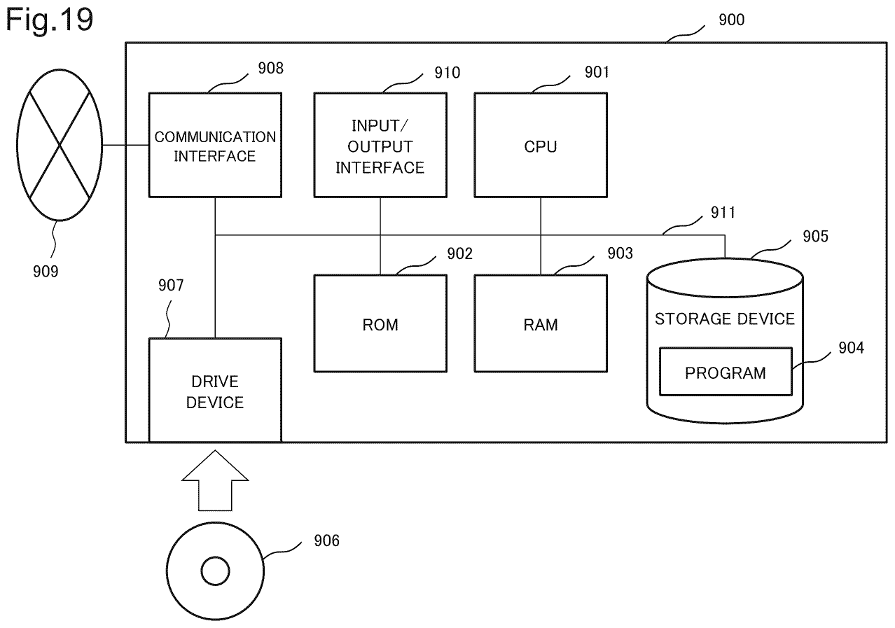

In each example embodiment of the present disclosure, the components of each device indicate functional unit blocks. Some or all of the components of each device are implemented by, for example, any combination of an information processing device 900 and a program as illustrated in FIG. 19. FIG. 19 is a block diagram illustrating an example of a hardware configuration of the information processing device 900 that implements the components of each device. The information processing device 900 has the following configuration by way of example.
A central processing unit (CPU) 901
A read only memory (ROM) 902
A random access memory (RAM) 903
A program 904 loaded to the RAM 903
A storage device 905 storing the program 904
A drive device 907 that performs reading and writing on a recording medium 906
A communication interface 908 connected to a communication network 909
An input/output interface 910 for inputting/outputting data
A bus 911 connecting the components

Each component of each device in each example embodiment is implemented by the CPU 901 acquiring and executing the program 904 for implementing these functions. That is, it is sufficient if the CPU 901 of FIG. 19 executes an accident detection program and an image selection program to execute update processing for each calculation parameter held in the RAM 903, the storage device 905, or the like. The program 904 for implementing the function of each component of each device is stored in advance in a program recording medium such as the storage device 905 or the ROM 902, and is read by the CPU 901 as necessary. The program 904 may be supplied to the CPU 901 via the communication network 909, or may be stored in advance in the program recording medium 906, and the drive device 907 may read the program and supply the program to the CPU 901.

In addition, the program 904 can display a processing result including an intermediate state for each stage via the display device as necessary, or can communicate with the outside via the communication interface. In addition, the program 904 can be recorded in a computer-readable (non-transitory) program storage medium.

There are various modified examples of the method of implementing each device. For example, each device may be implemented by any combination of the information processing device 900 and the program for each component. A plurality of components included in each device may be implemented by any combination of one information processing device 900 and the program. That is, the communication terminal and network control device described in the first to third example embodiments described above can be implemented by a computer program that causes a processor mounted in each of the devices to perform each of the above-described processings by using the hardware.

In addition, some or all of the components of each device are implemented by another general-purpose or dedicated circuitry, processor, or the like, or a combination thereof. These may be implemented by a single chip or may be implemented by a plurality of chips connected via a bus.

Some or all of the components of each device may be implemented by a combination of the above-described circuitry or the like and the program.

In a case where some or all of the components of each device are implemented by a plurality of information processing devices, circuitries, and the like, the plurality of information processing devices, circuitries, and the like may be arranged in a centralized manner or in a distributed manner. For example, the information processing device, the circuitry, and the like may be implemented as a form in which each is connected via a communication network, such as a client and server system or a cloud computing system.

Each of the above-described example embodiments is a preferred example embodiment of the present disclosure, and the scope of the present disclosure is not limited only to each of the above-described example embodiments. That is, it is possible for those of ordinary skill in the art to make modifications and substitutions of the above-described example embodiments without departing from the gist of the present disclosure, and to construct a mode in which various modifications are made.

Some or all of the above-described example embodiments can also be described as the following Supplementary Notes, but are not limited thereto.

### Supplementary Note 1

An information providing device including:
image acquisition means for acquiring an image obtained by imaging a monitoring target object from image storage means for storing the image for a predetermined period;
accident detection means for detecting occurrence of an accident that has caused damage to the monitoring target object based on a change of the image;
first image selection means for selecting, in a case where the occurrence of the accident has been detected, an image including an image before the occurrence of the accident from the image storage means; and
transmission means for transmitting, in a case where the occurrence of the accident has been detected, the image selected by the first image selection means and information regarding a portion where the change of the monitoring target object is detected to a predetermined terminal.

### Supplementary Note 2

The monitoring target object monitored by the information providing device can be any one of a land fixture and a parked vehicle, and
the image storage means can receive an image obtained by imaging the monitoring target object from a first camera that can image the monitoring target object and store the image for a predetermined period.

### Supplementary Note 3

The information providing device can further include second image selection means for selecting an image showing a vehicle that has caused the accident from the image storage means,
in which the image selected by the second image selection means can be transmitted to the predetermined terminal.

### Supplementary Note 4

The image storage means can receive an image before the accident of a vehicle that has caused the accident from a second camera arranged at a predetermined position and store the image for a predetermined period,
the information providing device can further include third image selection means for selecting an image before the accident of the vehicle that has caused the accident from the image storage means, and
the image selected by the third image selection means can be transmitted to the predetermined terminal.

### Supplementary Note 5

In the information providing device, monitoring target object information that stores manager information including at least a contact of the monitoring target object is acquirable, and
a terminal of a manager of the damaged monitoring target object can be selected as the predetermined terminal.

### Supplementary Note 6

An accident information providing method including:
acquiring an image obtained by imaging a monitoring target object from image storage means for storing the image for a predetermined period;
detecting occurrence of an accident that has caused damage to the monitoring target object based on a change of the image; and
transmitting, in a case where the occurrence of the accident has been detected, an image before the occurrence of the accident from the image storage means and information regarding a portion where the change of the monitoring target object is detected to a predetermined terminal.

### Supplementary Note 7

A program recording medium recording a program for causing a computer to execute processing of:
acquiring an image obtained by imaging a monitoring target object from image storage means for storing the image for a predetermined period;
detecting occurrence of an accident that has caused damage to the monitoring target object based on a change of the image; and
transmitting, in a case where the occurrence of the accident has been detected, an image before the occurrence of the accident from the image storage means and information regarding a portion where the change of the monitoring target object is detected to a predetermined terminal.

The modes of Supplementary Notes 6 and 7 can be extended in the modes of Supplementary Notes 2 to 5 like Supplementary Note 1.

The disclosures of the above-described patent literatures are incorporated herein by reference, and can be used as a basis or part of the present invention as necessary. Within the range of the entire disclosure (including the claims) of the present invention, it is possible to change and adjust the example embodiments or examples further based on the basic technical idea thereof. In addition, various combinations or selections (including partial deletions) of various disclosed elements (including the elements of the claims, the elements of the example embodiments or examples, the elements of the drawings, and the like) can be made within the range of the disclosure of the present invention. That is, it is a matter of course that the present invention includes various modifications and corrections that can be made by those of ordinary skill in the art in accordance with the entire disclosure including the claims and the technical idea. In particular, for numerical ranges set forth herein, any numerical value or sub-range included within the range should be construed as being specifically described, even if not stated otherwise. In addition, as needed and based on the gist of the present invention, partial or entire use of the disclosed matters in the above cited literatures in combination with the matters disclosed in the present application should be deemed to be included in the matters disclosed in the present application, as a part of the disclosure of the present invention.

### Reference Signs List

10, 100, 100a, 100b Information providing device
11, 101 Image acquisition means
12, 102 Accident detection means
13, 103 First image selection means
14, 104 Transmission means
20, 120 Image storage means
30 Terminal
31 Terminal of road manager
32 Terminal of property insurance company
50, 150 Camera
105 Second image selection means
106 Third image selection means
107 Transmission destination specifying means
108 Monitoring target object database (monitoring target object DB)
900 Information processing device
901 CPU (Central Processing Unit)
902 ROM (Read Only Memory)
903 RAM (Random Access Memory)
904 Program
905 Storage device
906 Program recording medium
907 Drive device
908 Communication interface
909 Communication network
910 Input/output interface
911 Bus
F-1 to F-5 Fence
V Vehicle

What is claimed is:

1. An information providing device comprising:
one or more memories storing instructions; and
one or more processors configured to execute the instructions to:
acquire an image obtained by imaging a monitoring target object from image storage storing the image for a predetermined period;
detect occurrence of an accident that has caused damage to the monitoring target object based on a change of the image;
select, in a case where the occurrence of the accident has been detected, a first image before the occurrence of the accident from the image storage; and
transmit, in a case where the occurrence of the accident has been detected, the first image and information regarding a portion where the change of the monitoring target object is detected to a predetermined terminal.

2. The information providing device according to claim 1, wherein
the monitoring target object is any one of a land fixture and a parked vehicle, and
the image storage receives the image from a first camera configured to image the monitoring target object and stores the image for the predetermined period.

3. The information providing device according to claim 1, wherein the one or more processors configured to execute the instructions to:
select a second image showing a vehicle that has caused the accident from the image storage; and
transmit the second image to the predetermined terminal.

4. The information providing device according to claim 3, wherein
the image storage receives a vehicle image before the accident of the vehicle that has caused the accident from a second camera arranged at a predetermined position and stores the vehicle image for the predetermined period,
and wherein the one or more processors further configured to execute the instructions to:
select a third image before the accident of the vehicle that has caused the accident from the image storage; and
transmit the third image to the predetermined terminal.

5. The information providing device according to claim 1, wherein the one or more processors further configured to execute the instructions to:
select a terminal of a manager of the damaged monitoring target object as the predetermined terminal based on monitoring target object information including manager information including at least a contact of the monitoring target object.

6. An accident information providing method comprising:
acquiring an image obtained by imaging a monitoring target object from image storage storing the image for a predetermined period;
detecting occurrence of an accident that has caused damage to the monitoring target object based on a change of the image; and
transmitting, in a case where the occurrence of the accident has been detected, a first image before the occurrence of the accident from the image storage and information regarding a portion where the change of the monitoring target object is detected to a predetermined terminal.

7. A program recording medium recording a program for causing a computer to execute processing of:
acquiring an image obtained by imaging a monitoring target object from image storage storing the image for a predetermined period;
detecting occurrence of an accident that has caused damage to the monitoring target object based on a change of the image; and
transmitting, in a case where the occurrence of the accident has been detected, a first image before the occurrence of the accident from the image storage and information regarding a portion where the change of the monitoring target object is detected to a predetermined terminal.
